(19) United States
(12) Patent Application Publication
(10) Pub. No.: US 2016/0055753 A1
(43) Pub. Date: Feb. 25, 2016

(54) SYSTEM AND METHOD FOR MAXIMIZING DISPLAYING OF TRAJECTORY ELEMENTS IN AN EDIT AREA OF A NAVIGATIONAL DISPLAY OF A COCKPIT DISPLAY SYSTEM

(71) Applicant: AIRBUS ENGINEERING CENTRE INDIA, Bangalore, Karnataka (IN)

(72) Inventors: MAYANK JAIN, Bangalore (IN); RAVI SHANKAR KUMAR, Bangalore (IN)

(21) Appl. No.: 14/779,036

(22) PCT Filed: Oct. 4, 2013
(86) PCT No.: PCT/IN13/00605

§ 371 Date: Sep. 22, 2015

(30) Foreign Application Priority Data
Oct. 5, 2012 (IN) 4155/CHE/2012

(51) Int. Cl. G08G 5/00; G01C 23/00

(52) U.S. Cl. CPC G08G 5/0034; G01C 23/005

(57) ABSTRACT

A system and method for maximizing displaying of trajectory elements in an edit area of a navigational display are disclosed. In one embodiment, navigational display parameters are obtained from a cockpit display system. Further, flight plan information is obtained from a flight management system (FMS). Furthermore, a portion of the flight plan information which lies within the edit area of the navigation display is dynamically determined using the navigational display parameters. In addition, a display buffer is dynamically populated with only the determined portion of the flight plan information. Moreover, any needed data that is in the determined portion of the flight plan information is dynamically refreshed in the display buffer. Also, the flight plan information is dynamically displayed on the edit area of the navigation display using the refreshed and populated flight plan information and the needed data.

### FIELD OF TECHNOLOGY

Embodiments of the present subject matter generally relate to a navigational display, and more particularly, to trajectory elements displayed in an edit area of the navigational display.

### BACKGROUND

Typically, various data associated with trajectory elements are available in a flight management system to provide positions of selected features that can be important to be displayed in a navigational display during the flight of an aircraft. For example, the trajectory elements, such as location of airports, geographical features, navigational aids (e.g., beacons), landmarks on or near a flight path, and arrival locations are stored in the flight management system and can be displayed as icons, in response to activation by an operator, as an overlay on the navigational display. These icons can represent, for example, airports, geographical waypoints and non-directional navigation beacons. The icons can also have alpha numeric information associated therewith identifying the icons. As the area available for display on the navigational display becomes larger, increasing number of icons may be displayed.

However, such display of icons is, typically, limited by a storage capacity of a navigational display buffer storage unit. Generally, the navigational display buffer storage unit contains all the information related to features that are important to navigation permitting a display apparatus to provide the icons representing the important features on the display screen of the navigational display. The feature information is, in turn, retrieved from the flight management system containing all of the features information and stored in the navigational display buffer storage unit accordingly to a preselected algorithm. Typically, the navigational display buffer storage unit is limited in capacity and the number of icons that can be displayed on the display screen can be limited. This can result in not displaying more important needed trajectory element information because of the limited storage capacity of the navigational display buffer storage unit and also due to storing of unimportant and non-viewable data in the navigational display buffer storage unit. This can further result in compromising the usefulness of the navigational display in a decision process during the flight. One existing method uses inequalities equations in an algorithm to determine the existence of the trajectory element in an edit area of the navigational display and may not result in maximizing the feature information that can be displayed in the edit area of the navigational display.

### SUMMARY

A system and method for maximizing displaying of trajectory elements in an edit area of a navigational display of a cockpit display system are disclosed. According to one aspect of the present subject matter, navigational display parameters are obtained from the cockpit display system. Further, flight plan information is obtained from a flight management system (FMS). Furthermore, a portion of the flight plan information which lies within the edit area of the navigational display is dynamically determined using the navigational display parameters. In addition, a display buffer is dynamically populated with only the determined portion of the flight plan information. Moreover, any needed data that is in the determined portion of the flight plan information is dynamically refreshed in the display buffer. Also, the flight plan information is dynamically displayed on the edit area of the navigational display using the refreshed and populated flight plan information and the needed data.

According to another aspect of the present subject matter, an aircraft includes the FMS and the cockpit display system communicatively coupled to the FMS. Further, the FMS includes a processor and memory coupled to the processor. Furthermore, the memory includes a trajectory element database to store the flight plan information. In addition, the cockpit display system includes the navigational display, a processor coupled to the navigational display and memory coupled to the processor. Moreover, the memory includes a trajectory element display module.

In operation, the trajectory element display module obtains the navigational display parameters from the cockpit display system. Further, the trajectory element display module obtains the flight plan information from the trajectory element database. Furthermore, the trajectory element display module dynamically determines which portion of the flight plan information lies within the edit area of the navigational display using the navigational display parameters. Moreover, the trajectory element display module dynamically populates the display buffer with only the determined portion of the flight plan information. Also, the trajectory element display module dynamically refreshes any needed data that is in the determined portion of the flight plan information in the display buffer. Further, the trajectory element display module dynamically displays the flight plan information on the edit area of the navigational display using the refreshed and populated flight plan information and the needed data.

According to another aspect of the present subject matter, a non-transitory computer-readable storage medium for maximizing displaying of the trajectory elements in the edit area of the navigational display of the cockpit display system, having instructions that, when executed by a computing device causes the computing device to perform the method described above.

The systems and methods disclosed herein may be implemented in any means for achieving various aspects. Other features will be apparent from the accompanying drawings and from the detailed description that follow.

### BRIEF DESCRIPTION OF THE DRAWINGS

Various embodiments are described herein with reference to the drawings, wherein:

FIG. 1A is a schematic illustrating displaying a trajectory, at an initial point, by a navigational display of a cockpit display system, in the context of the invention;

FIG. 1B is a schematic illustrating displaying of a portion of the trajectory, at a point in time, by the navigational display of the cockpit display system, in the context of the invention;

FIG. 2 is a schematic illustrating an edit area of the navigational display, in the context of the invention;

FIG. 3 illustrates a flowchart of an exemplary method for maximizing displaying of trajectory elements in the edit area of the navigational display of the cockpit display system, according to one embodiment;

FIG. 4 is a schematic illustrating a point which needs to be determined whether it lies within the edit area, according to one embodiment;

FIG. 5 illustrates a flow diagram of an exemplary method of computing all points lying within the edit area, such as shown in FIG. 4, according to one embodiment;

FIGS. 6A-6D are schematics illustrating lines on a trajectory, according to one embodiment;

FIG. 7 illustrates a flow diagram of an exemplary method of computing all lines lying within the edit area, such as shown in FIGS. 6A-6D, according to one embodiment;

FIG. 8 is a schematic illustrating an intercept point on a line joining two other points on the trajectory, according to one embodiment;

FIGS. 9 and 10 illustrate flow diagrams of exemplary methods of computing all points lying on the lines connecting associated start and end points within the edit area of the navigational display, such as shown in FIG. 7, according to one embodiment;

FIGS. 11A-11D are schematics illustrating arcs on the trajectory, according to one embodiment;

FIG. 12 illustrates a flow diagram of an exemplary method of determining all arcs that are within the edit area of the navigational display, such as shown in FIGS. 11A-11D, according to one embodiment;

FIGS. 13A and 13B are schematics illustrating logic/computation used to determine an intercept point and to determine whether the intercept point lies on an arc connecting two other points, respectively, according to one embodiment;

FIGS. 14A and 14B illustrate flow diagrams of exemplary methods of determining the one or more points lie on the arc connecting two other points within the edit area of the navigational display, such as shown in FIGS. 13A-13B, according to one embodiment; and

FIG. 15 is a block diagram illustrating an aircraft including a trajectory element display module for maximizing displaying of trajectory elements in the edit area of the navigational display of the cockpit display system, according to one embodiment.

The drawings described herein are for illustration purposes only and are not intended to limit the scope of the present disclosure in any way.

### DETAILED DESCRIPTION

A system and method for maximizing displaying of trajectory elements in an edit area of a navigational display of a cockpit display system are disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

The terms “trajectory elements” and “icons” are used interchangeably throughout the document. Further, the terms “navigational display buffer storage unit” and “display buffer” are used interchangeably throughout the document.

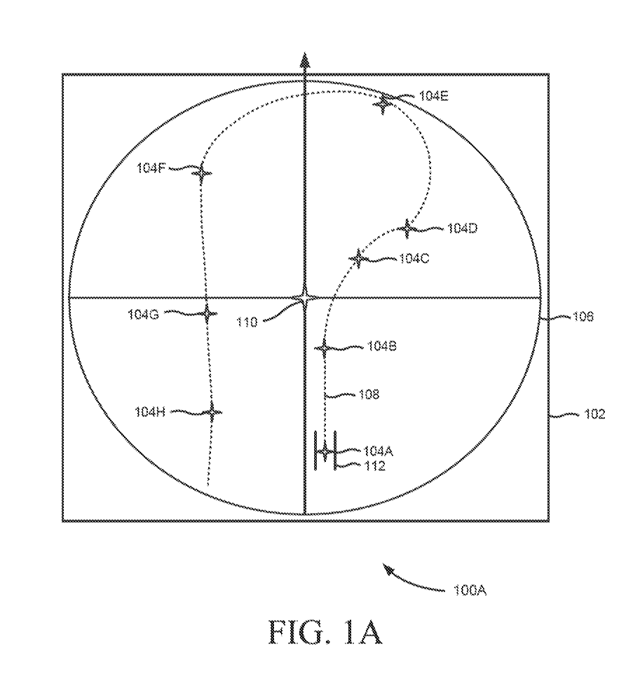

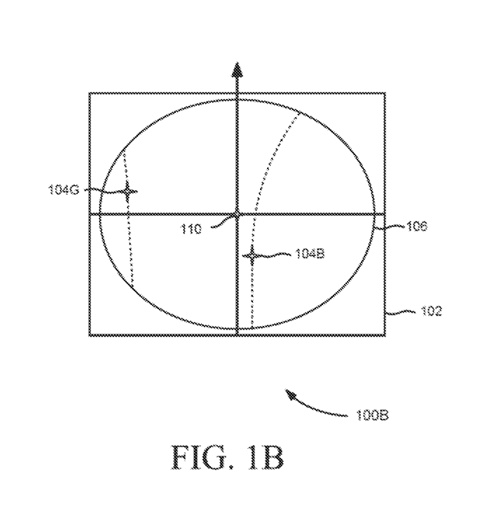

FIG. 1A is a schematic 100A illustrating displaying a trajectory 108, at an initial point, by a navigational display 102 of a cockpit display system, in the context of the invention. Particularly, the trajectory 108, to be flown by an aircraft, is displayed on an edit area 106 of the navigational display 102 at the initial point of the flight of the aircraft. As shown in FIG. 1A, the trajectory 108 includes waypoint information associated with waypoints 104A-H. For example, the waypoint 104A is the initial point on a runway 112. Exemplary waypoints include fixed points on earth with particular latitude/longitude values. The trajectory 108 is determined with reference to a map reference point (MRP) 110. For example, the MRP 110 includes a waypoint, an aircraft or any fixed point which lies in the edit area 106 of the navigational display 102.

Referring now to FIG. 1B, which is a schematic 100B illustrating displaying of a portion of the trajectory 108, at a point in time, by the navigational display 102 of the cockpit display system, in the context of the invention. As shown in FIG. 1B, the portion of the trajectory 108 including the way points 104B and 104G is displayed by the navigational display 102 at the point in time.

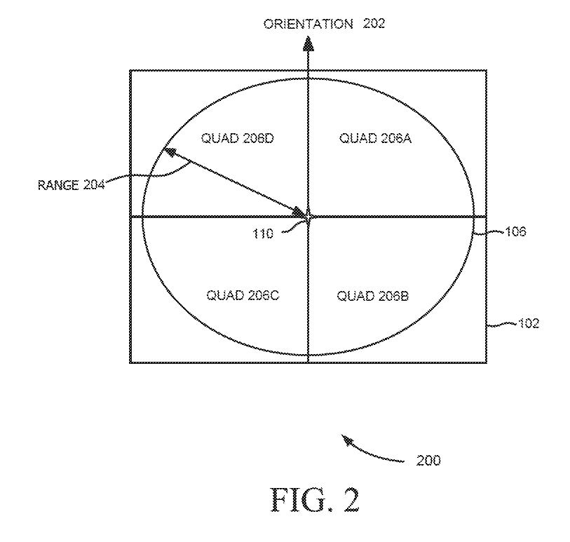

Referring now to FIG. 2, which is a schematic 200 that illustrates the edit area 106 of the navigational display 102, in the context of the invention. As shown in FIG. 2, the edit area 106 is partitioned into four quadrants 206A-D (quads 206A-D) with ranges 0-90 degrees (inclusive 90), 90-180 degrees (inclusive 180), 180-270 degrees (inclusive 270) and 270-360 degrees (inclusive 360 or 0), respectively. Further, a range 204 indicates a range of the navigational display 102. For example, the range 204 is adjusted by the pilot with reference to the MRP 110. Furthermore, an orientation 202 indicates an orientation of the navigational display 102 determined with reference to a true north.

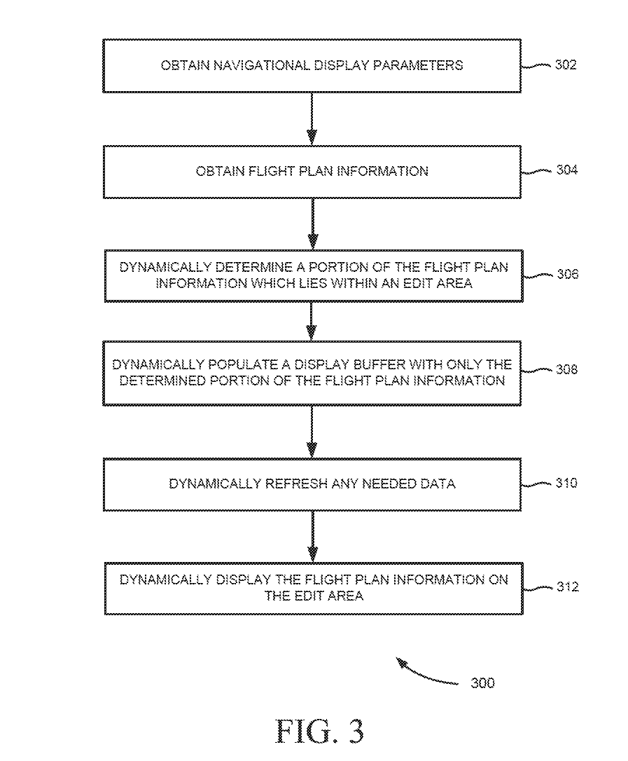

Referring now to FIG. 3, which is a flowchart 300 that illustrates an exemplary method for maximizing displaying of trajectory elements in an edit area of a navigational display of a cockpit display system, according to one embodiment. At block 302, navigational display parameters are obtained from the cockpit display system. For example, the navigational display parameters include a MRP, a range of the navigational display, an orientation of the navigational display, edit area boundary dimensions and the like. At block 304, flight plan information is obtained from a flight management system (FMS). For example, the flight plan information includes flight path information, way point information, airport information, navigation aids information and the like defined by points, lines and arcs. At block 306, a portion of the flight plan information which lies within the edit area of the navigational display is dynamically determined using the navigational display parameters. In one embodiment, the edit area is partitioned into quadrants. Further, the defined points, lines and arcs which are within one or more of the quadrants of the edit area are determined using point, line and arc logics, respectively.

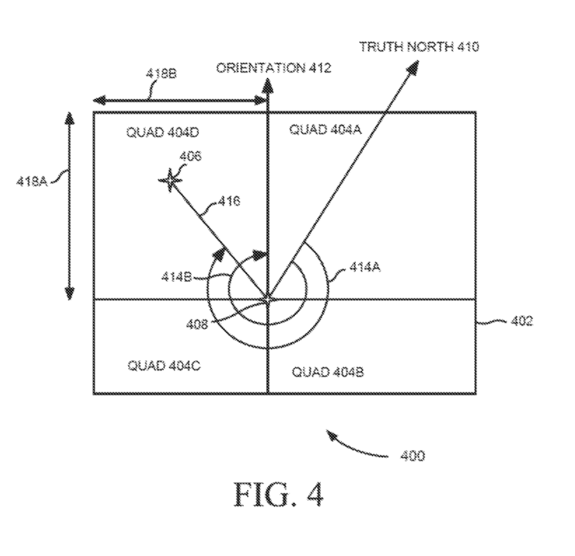

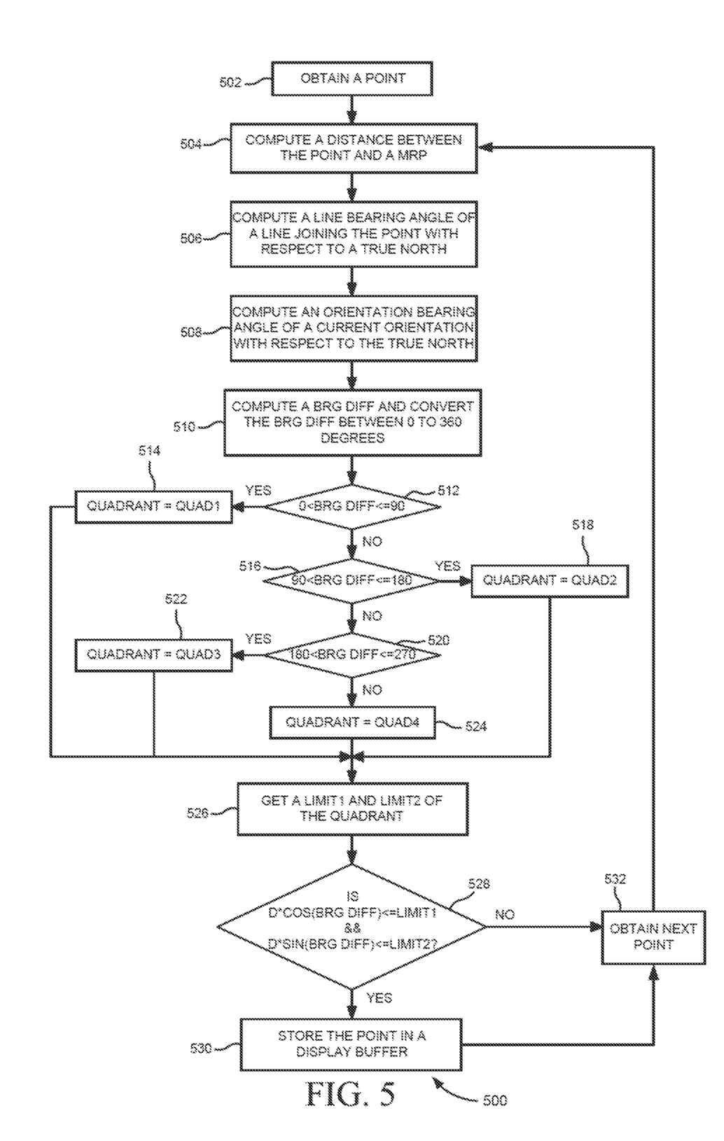

In one exemplary embodiment, the method for determining which of the defined points are within the edit area of the navigational display using the point logic includes computing a distance between each defined point and the MRP. Further, an orientation bearing angle with respect to a true north is determined using a sodano equation. Furthermore, a line bearing angle of a line joining each defined point and the MRP is determined with respect to the true north using the sodano equation. In addition, a bearing angle difference between the orientation bearing angle and the line bearing angle is determined. Moreover, the quadrant in which the each defined point lies is determined using the bearing angle difference. Also, it is determined whether the defined points lie within the boundary limits of the determined quadrant. Further, the defined points are declared to display in the edit area based on the outcome of the above determination. This is explained in more detail with reference to FIGS. 4 and 5.

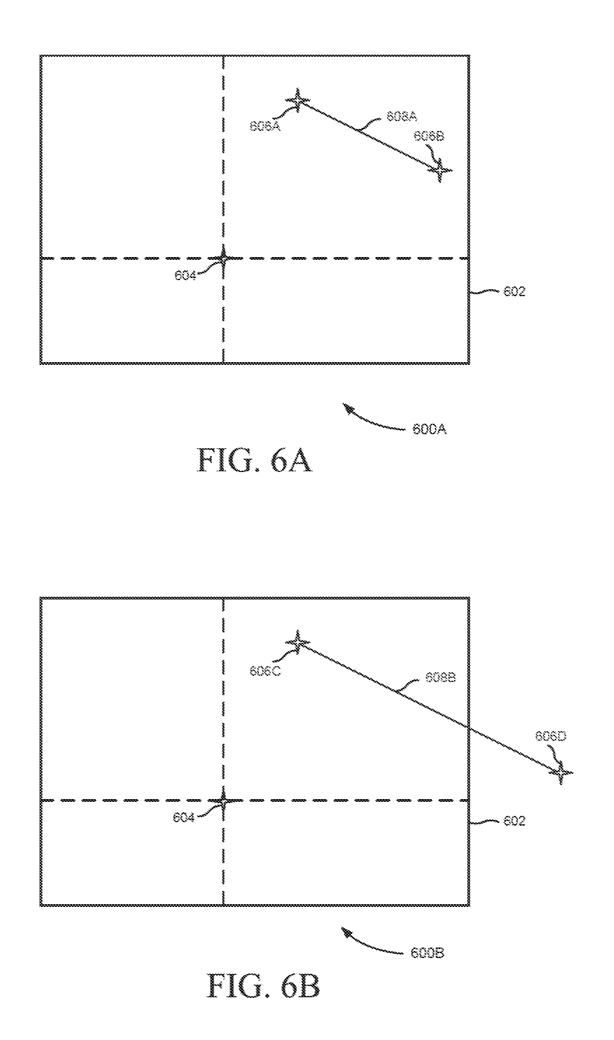

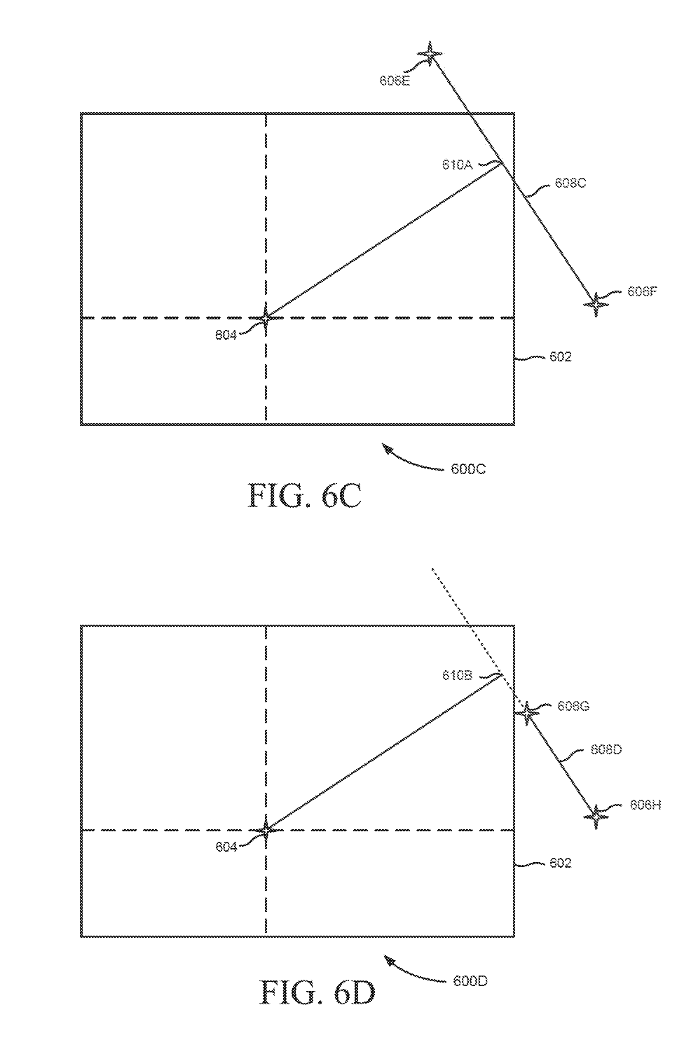

In one exemplary embodiment, the method for determining which of the defined lines are within the edit area of the navigational display using the line logic includes determining whether a complete or a portion of each line is in the edit area using whether one of a start point position of the line, an end point position of the line, and an intercept point position on the line from the MRP is in the edit area using the point logic. Further, the defined lines are declared to display in the edit area based on the outcome of the above determination. This is explained in more detail with reference to FIGS. 6A-6D to FIG. 10.

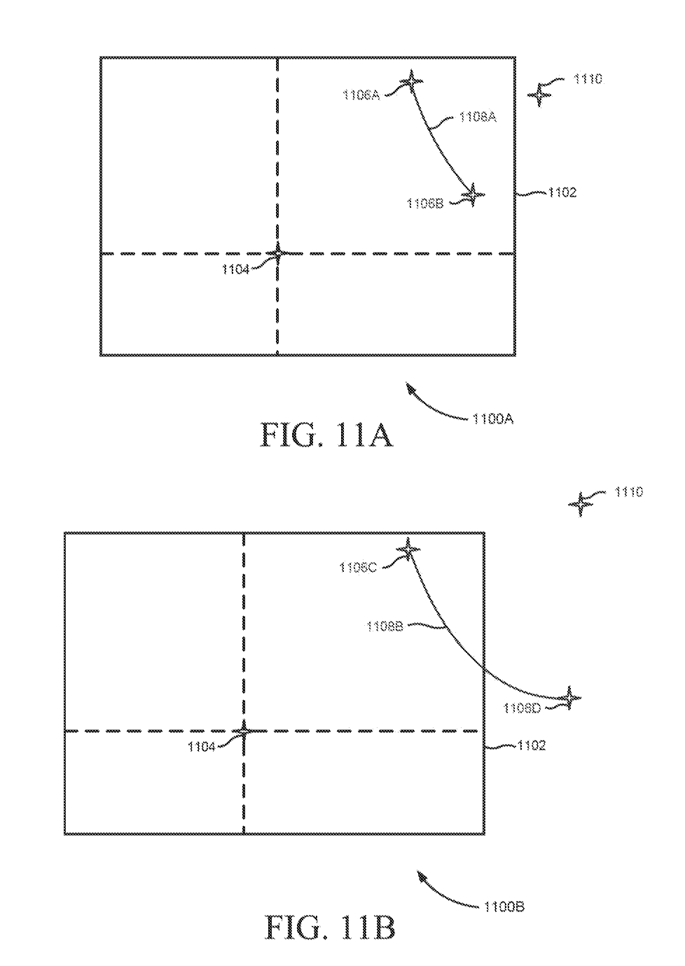

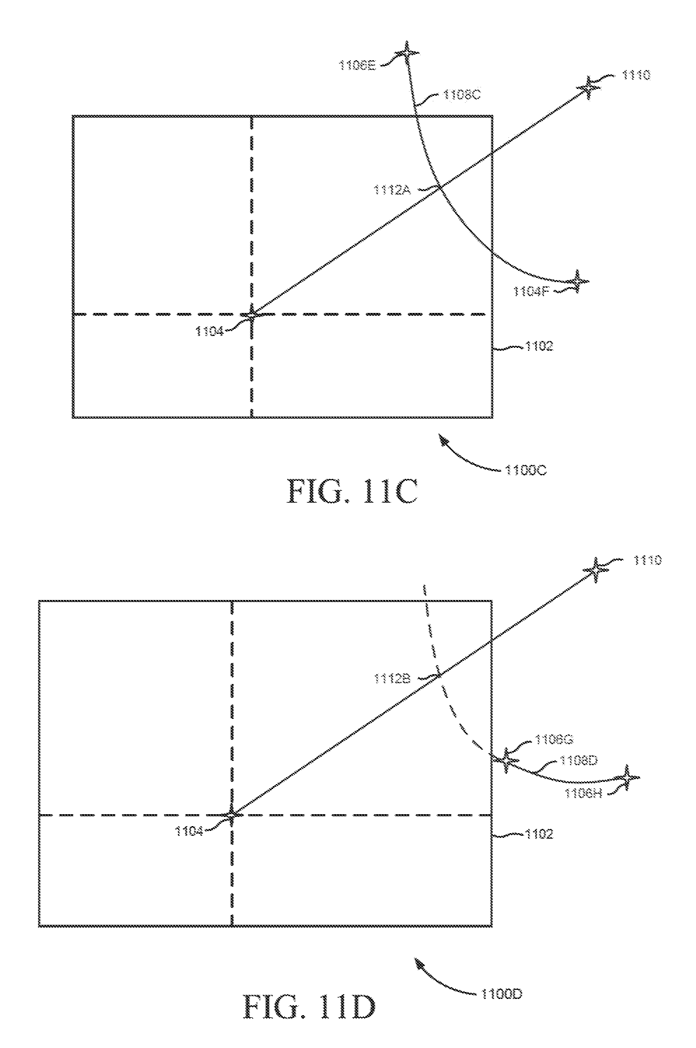

In one exemplary embodiment, the method for determining which of the defined arcs are within the edit area of the navigational display using the arc logic includes determining whether a complete or a portion of each arc is in the edit area using whether one of a start point position of the arc, an end point position of the arc, and an intercept point position in the edit area using the point logic. For example, the intercept point position is where the line joining the MRP and an arc center intercepts with the arc. Further, the defined arcs are declared to display in the edit area based on the outcome of the above determination. This is explained in more detail with reference to FIGS. 11A-11D to FIGS. 14A-14B.

At block 308, a display buffer is dynamically populated with only the determined portion of the flight plan information. At block 310, any needed data that is in the determined portion of the flight plan information is dynamically refreshed in the display buffer. For example, the data includes the trajectory elements, such as airports, geographical waypoints, non-directional navigation beacons, landmarks on or near a flight path, arrival locations and the like. At block 312, the flight plan information is dynamically displayed on the edit area of the navigational display using the refreshed and populated flight plan information and the needed data.

Referring now to FIG. 4, which is a schematic 400 that illustrates a point 406 which needs to be determined whether it lies within an edit area 402, according to one embodiment. As shown in FIG. 4, the edit area 402 is partitioned into four quads 404A-D. Further, a bearing angle 414A is a line bearing angle of a line joining the point 406 and a MRP 408 with respect to a true north 410. Furthermore, a bearing angle 414B is an orientation bearing angle of a current orientation 412 with respect to the true north 410. In addition, limits 418A-B are boundary limits of a quadrant in which the point 406 exists. In this embodiment, the point 406 exists in the quad 404D. Moreover, a distance 416 is a distance between the point 406 and the MRP 408. In one embodiment, a process to determine the existence of all points in the edit area 402 which needs to be populated in the display buffer for the navigation display is explained in more detail with reference to FIG. 5. In one exemplary embodiment, existence of the points in the edit area 402 is determined on basis of their position (e.g., latitudes and longitudes).

Referring now to FIG. 5, which is a flow diagram 500 that illustrates an exemplary method of determining all points lying within an edit area, such as shown in FIG. 4, according to one embodiment. In one embodiment, the edit area is partitioned into four quadrants (quad1, quad2, quad3 and quad4). At block 502, a point on a trajectory is obtained. At block 504, a distance (D) between the point and a MRP is computed. At block 506, a line bearing angle of a line joining the point and MRP with respect to a true north is computed. At block 508, an orientation bearing angle of a current orientation with respect to the true north is computed. At block 510, a bearing angle difference (BRG DIFF) between the line bearing angle and orientation bearing angle is computed and the computed BRG DIFF is then converted between 0 to 360 degrees.

At block 512, it is determined whether the BRG DIFF is greater than 0 degrees and less than or equal to 90 degrees. At block 514, declare the point exists in the quad (e.g., a quad 404A of FIG. 4) if the BRG DIFF is greater than 0 degrees and less than or equal to 90 degrees. At block 516, it is determined whether the BRG DIFF is greater than 90 degrees and less than or equal to 180 degrees if the BRG DIFF is not greater than 0 degrees and not less than or equal to 90 degrees. At block 518, declare the point exists in the quad2 (e.g., a quad 404B of FIG. 4) if the BRG DIFF is greater than 90 degrees and less than or equal to 180 degrees. At block 520, it is determined whether the BRG DIFF is greater than 180 degrees and less than or equal to 270 degrees if the BRG DIFF is not greater than 90 degrees and not less than or equal to 180 degrees. At block 522, declare the point exists in the quad3 (e.g., a quad 404C of FIG. 4) if the BRG DIFF is greater than 180 degrees and less than or equal to 270 degrees. At block 524, declare the point exists in the quad4 (e.g., a quad 404D of FIG. 4) if the BRG DIFF is not greater than 180 degrees and not less than or equal to 270 degrees.

At block 526, obtain limits (limit 1 and limit 2) of the quadrant in which the point exists. At block 528, it is determined whether a product of the D and cosine of the BRG DIFF is less than or equal to the limit 1 and a product of the D and sine of BRG DIFF is less than or equal to the limit 2. At block 530, the point is stored in a display buffer if the product of the D and cosine of BRG DIFF is less than or equal to the limit 1 and the product of the D and sine of BRG DIFF is less than or equal to the limit 2. At block 532, next point is obtained if the product of the D and cosine of BRG DIFF is greater than the limit 1 and the product of the D and sine of BRG DIFF is greater than the limit 2 and upon storing the point in the display buffer. Further, the process steps from block 504 are repeated.

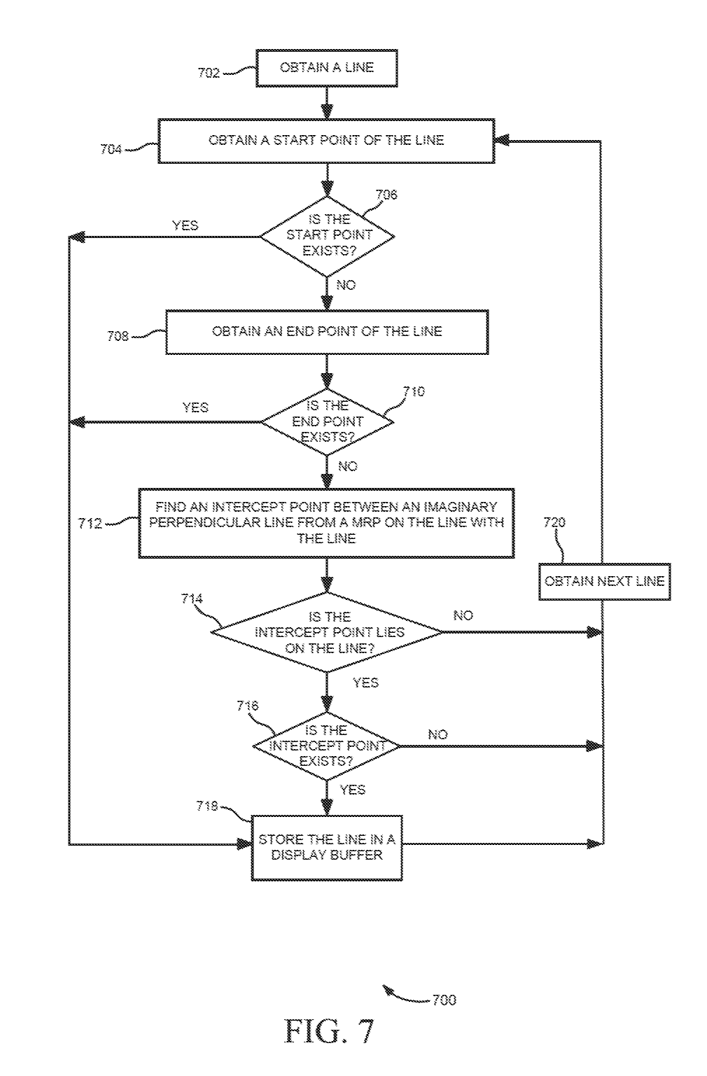

Referring now to FIGS. 6A-6D, which are schematics 600A-D illustrating lines 608A-D on a trajectory, according to one embodiment. Particularly, FIG. 6A illustrates the line 608A with points 606A-B within an edit area 602 with respect to a MRP 604. Further, FIG. 6B illustrates the line 608B with a point 606C within the edit area 602 and a point 606D outside the edit area 602 with respect to the MRP 604. Furthermore, FIG. 6C illustrates the line 608C passing through the edit area 602 with points 606E-F outside the edit area 602 and an intercept point 610A on the line 608C within the edit area 602, with respect to the MRP 604. In addition, FIG. 6D illustrates the line 608D not passing through the edit area 602 with points 606G-H outside the edit area 602 and an intercept point 610B within the edit area 602, with respect to the MRP 604. In one embodiment, the lines 608A-B are declared to be within the edit area 602 as at least one of the points 606A-B and 606C-D, respectively, lies within the edit area 602, using the logic defined in FIG. 5. Further, the lines 608C-D are declared to be within the edit area 602 by determining whether the intercept points 610A-B exist within the edit area 602 and on the lines 608C-D, respectively. This is explained in more detail with reference to FIGS. 7-10.

Referring now to FIG. 7, which is a flow diagram 700 that illustrates an exemplary method of determining all lines lying within an edit area, such as shown in FIGS. 6A-6D, according to one embodiment. At block 702, a line on a trajectory is obtained. At block 704, a start point of the line is obtained. At block 706, it is determined whether the start point exists in the edit area. In one embodiment, the existence of the start point in the edit area is determined using a logic described in FIG. 5. At block 718, the line is stored in a display buffer if the start point exists in the edit area. At block 708, an end point of the line is obtained if the start point does not exist in the edit area.

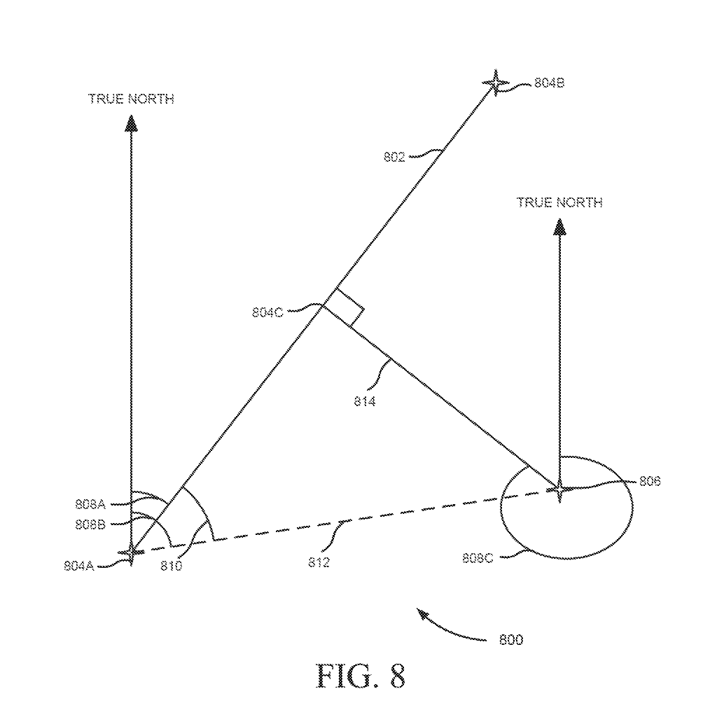

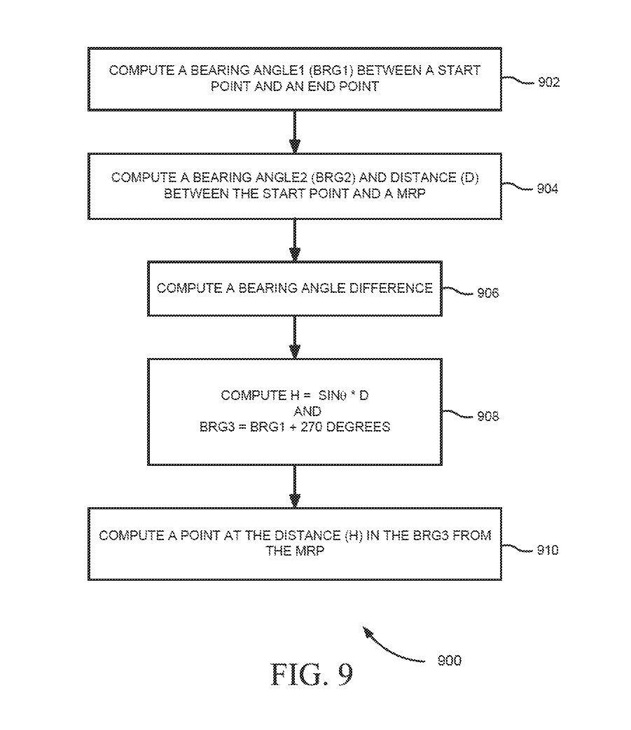

At block 710, it is determined whether the end point exists in the edit area. In one embodiment, the existence of the end point in the edit area is determined using the logic described in FIG. 5. At block 718, the line is stored in the display buffer if the end point exists in the edit area. At block 712, an intercept point between an imaginary perpendicular line from a MRP on the line with the line is found if the end point does not exist in the edit area. At block 714, it is determined whether the intercept point lies on the line. This is explained in more detail with reference to FIGS. 8 and 9. At block 716, it is determined whether the intercept point exists in the edit area if the intercept point lies on the line. In one embodiment, the existence of the intercept point in the edit area is determined using the logic described in FIG. 5. At block 718, the line is stored in the display buffer if the intercept point exists in the edit area. At block 720, next line is obtained if the intercept point does not exist on the line, if the intercept point does not exist in the edit area and upon storing the line in the display buffer. Further, the process steps from block 704 are repeated.

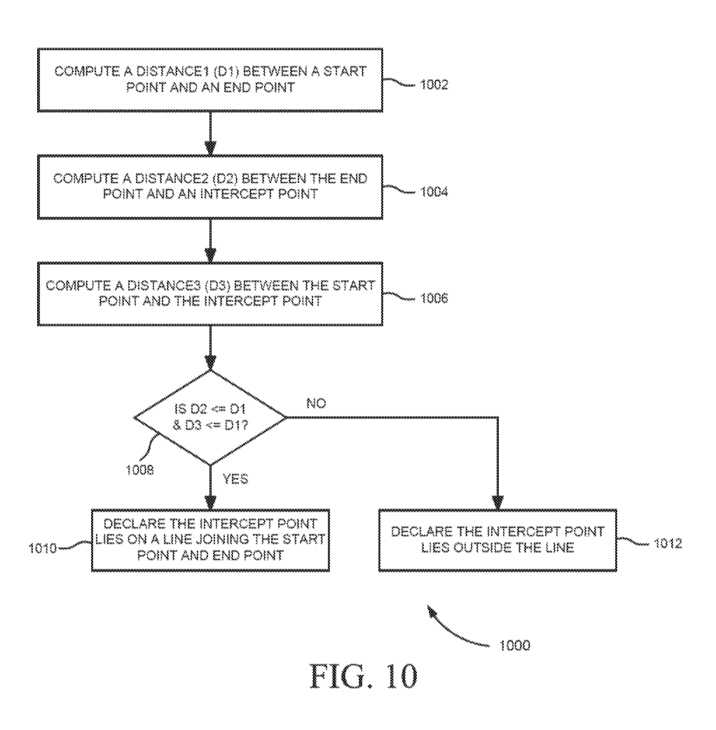

Referring now to FIG. 8, which is a schematic 800 that illustrates an intercept point 804C on a line 802 joining two other points 804A-B on a trajectory, according to one embodiment. As shown in the FIG. 8, a bearing angle 808A is a bearing angle of the line 802 with respect to a true north. Further, a bearing angle 808B is a bearing angle of a line joining the point 804A and a MRP 806 with respect to the true north. In one embodiment, the bearing angles 808A-B are computed using a sodano inverse equation. Furthermore, a bearing angle 808C is a bearing angle computed by adding 270 degrees to the bearing angle 808A. In addition, a bearing angle difference 810 is a bearing angle difference between the bearing angle 808A and bearing angle 808B. Moreover, a distance 812 is a distance between the point 804A and the MRP 806. Also, a distance 814 is a distance computed by multiplying sine of the bearing angle difference 810 and distance 812. In one exemplary embodiment, the intercept point 804C is computed at the distance 814 in the bearing angle 808C from the MRP 806 using a sodano direct equation. This is explained in more detail with reference to FIGS. 9 and 10.

FIGS. 9 and 10 illustrate flow diagrams 900 and 1000 of exemplary methods of computing all points lying on lines connecting associated start and end points on a trajectory, such as shown in FIG. 8, according to one embodiment. Particularly, FIG. 9 illustrates the flow diagram 900 of the exemplary method of determining an intercept point between an imaginary perpendicular line from a MRP on the line with the line. At block 902, a bearing angle1 (BRG1) between a start point and an end point of the line is computed using a sodano inverse equation. At block 904, a bearing angle2 (BRG2) and a distance (D) between the start point and the MRP are computed using the sodano inverse equation. At block 906, a bearing angle difference (θ) between BRG1 and BRG2 is computed. At block 908, a distance (H) is computed by multiplying sine of bearing angle difference and D. Further, a bearing angle3 (BRG3) is computed by adding 270 degrees to the BRG1. At block 910, the intercept point is determined at the H in the BRG3 from the MRP using a sodano direct equation.

Particularly, FIG. 10 illustrates the flow diagram 1000 of the exemplary method of determining whether the intercept point lies on the line joining the start point and end point. At block 1002, a distance1 (D1) between the start point and end point is computed using the sodano inverse equation. At block 1004, a distance2 (D2) between the end point and intercept point is computed using the sodano inverse equation. At block 1006, a distance3 (D3) between the start point and intercept point is computed using the sodano inverse equation. At block 1008, it is determined whether the D2 is less than or equal to the D1 and the D3 is less than or equal to the D1. At block 1010, it is declared that the intercept point lies on the line joining the start point and end point if the D2 is less than or equal to the D1 and the D3 is less than or equal to the D1. At block 1012, it is declared that the intercept point lies outside the line joining the start point and end point if the D2 is greater than the D1 and the D3 is greater than the D1.

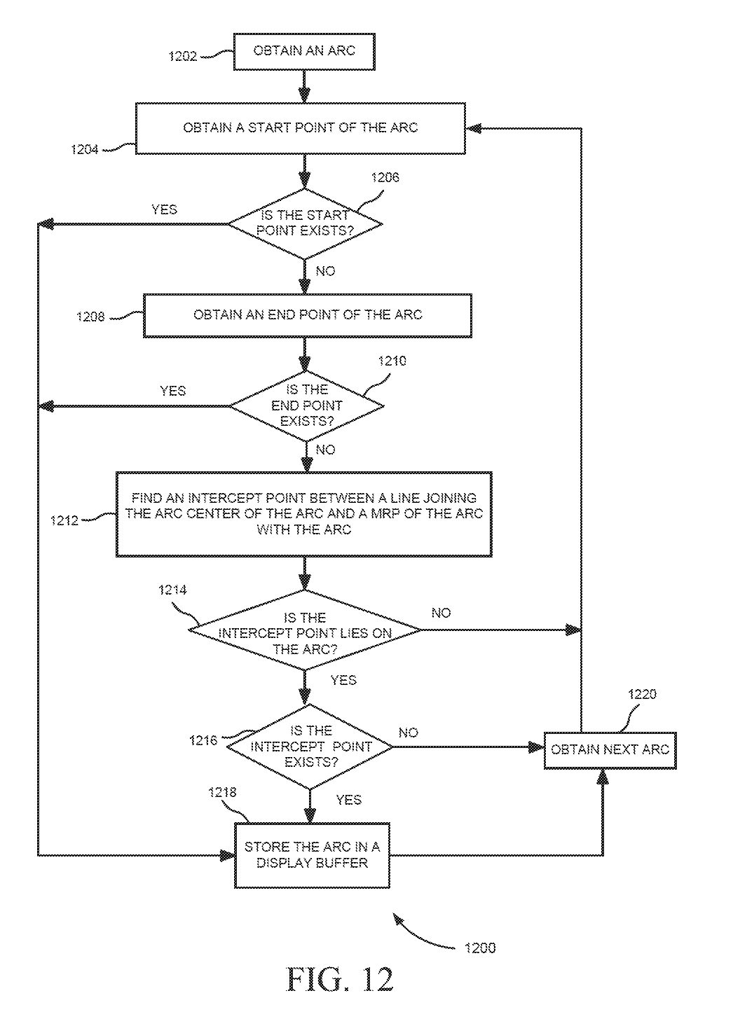

Referring now to FIGS. 11A-11D, which are schematics 1100A-D illustrating arcs 1108A-D on the trajectory, according to one embodiment. Particularly, FIG. 11A illustrates the arc 1108A with points 1106A-B within an edit area 1102 with respect to a MRP 1104. Further, FIG. 11B illustrates the arc 1108B with a point 1106C within the edit area 1102 and a point 1106D outside the edit area 1102 with respect to the MRP 1104. Furthermore, FIG. 11C illustrates the arc 1108C passing through the edit area 1102 with points 1106E-F outside the edit area 1102 and an intercept point 1112A on the line 608C within the edit area 602, with respect to the MRP 1104. For example, a position of the intercept point 1112A is where a line joining the MRP 1104 and an arc center 1110 intercepts with the arc 1108C. In addition, FIG. 11D illustrates the arc 1108D not passing through the edit area 1102 with points 1106G-H outside the edit area 1102 and an intercept point 1112B within the edit area 1102, with respect to the MRP 1104. For example, a position of the intercept point 1112B is where a line joining the MRP 1104 and the arc center 1110 intercepts with the arc 11080. In one embodiment, the arcs 1108A-B are declared to be within the edit area 1102 as at least one of the points 1106A-B and 1106C-D, respectively, lies within the edit area 1102, using the logic defined in FIG. 5. Further, the arcs 1108C-0 are declared to be within the edit area 1102 by determining the existence of the intercept points 1112A-B within the edit area 1102 and on the arcs 1108C-D, respectively. This is explained in more detail with reference to FIGS. 12-14.

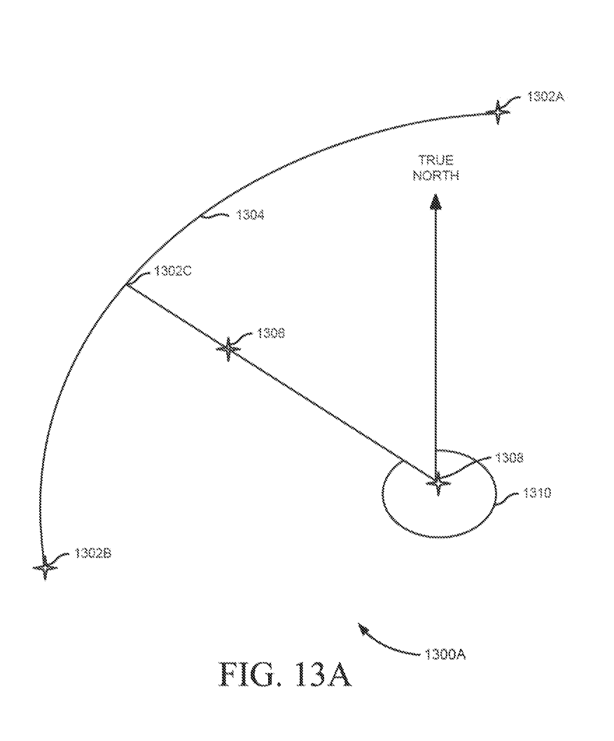

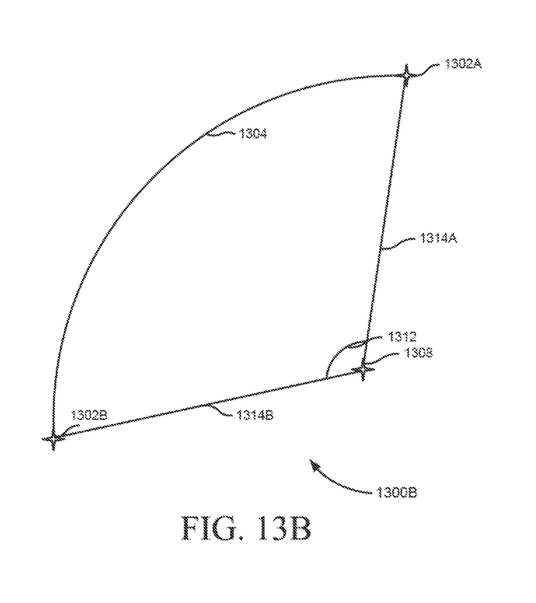

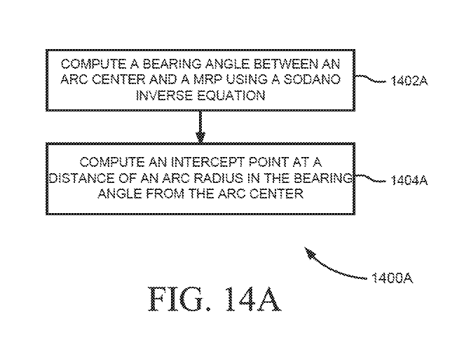

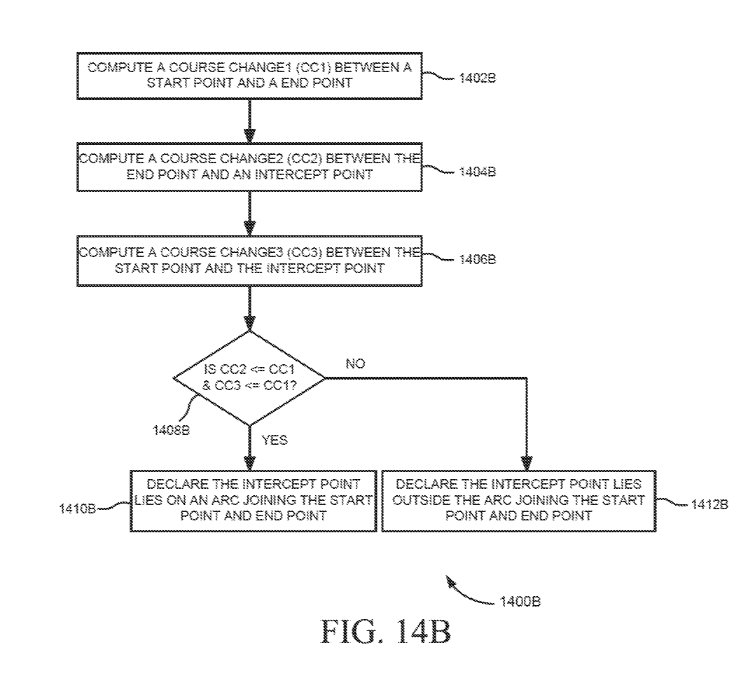

Referring now to FIG. 12, which is a flow diagram 1200 that illustrates an exemplary method of determining all arcs that are within an edit area of a navigational display, such as shown in FIGS. 11A-11D, according to one embodiment. At block 1202, an arc on a trajectory is obtained. At block 1204, a start point of the arc is obtained. At block 1206, it is determined whether the start point exists in the edit area. In one embodiment, the existence of the start point in the edit area is determined using the process described in FIG. 5. At block 1218, the arc is stored in a display buffer if the start point exists in the edit area. At block 1208, an end point of the arc is obtained if the start point does not exist in the edit area. At block 1210, it is determined whether the end point exists in the edit area. In one embodiment, the existence of the end point in the edit area is determined using the logic described in FIG. 5. At block 1218, the arc is stored in the display buffer if the end point exists in the edit area. At block 1212, an intercept point between an imaginary perpendicular line from a MRP on the arc with the arc is determined if the end point does not exist in the edit area. At block 1214, it is determined whether the intercept point lies on the arc. This is explained in more detail with reference to FIGS. 13 and 14. At block 1216, it is determined whether the intercept point exists in the edit area if the intercept point lies on the arc. In one embodiment, the existence of the intercept point in the edit area is determined using the logic described in FIG. 5. At block 1218, the arc is stored in the display buffer if the intercept point exists in the edit area. At block 1220, next arc on the trajectory is obtained if the intercept point does not exist in the edit area, if the intercept point does not lie on the arc and upon storing the arc in the display buffer. Further, the process steps from block 1204 are repeated.

Referring now to FIGS. 13A-B, which are schematics 1300A-B illustrating logic/computation used to determine an intercept point 1302C and to determine whether the intercept point 1302C lies on an arc 1304 connecting two other points 1302A-B, respectively, according to one embodiment. Particularly, FIG. 13A illustrates the intercept point 1302C on the arc 1304 at a distance of an arc radius in a bearing angle 1310 from an arc center 1308 through a MRP 1306. This is explained in more detail with reference to FIG. 14A. Particularly, FIG. 13B illustrates a course change 1312 between lines 1314A-B joining the points 1302A-B and the arc center 1308. The process of determining the intercept point 1302C on the arc 1304 is explained in more detail with reference to FIG. 14B.

Referring now to FIGS. 14A and 14B, which are flow diagrams 1400A and 1400B that illustrate exemplary methods of determining one or more points lie on an arc connecting start and end points, such as shown in FIGS. 13A-13B, according to one embodiment. Particularly, the flow diagram 1400A illustrates the exemplary method of determining an intercept point. At block 1402A, a bearing angle between an arc center and a MRP is computed using a sodano inverse equation. At block 1404A, the intercept point is determined at a distance of an arc radius in the bearing angle from the arc center using a sodano direct equation.

Particularly, the flow diagram 1400B illustrates the exemplary method of determining whether the intercept point lies on the arc joining the start point and the end point. At block 1402B, a course change1 (CC1) between the start point and end point is computed. At block 1404B, a course change2 (CC2) between the end point and intercept point is computed. At block 1406B, a course change3 (CC3) between the start point and intercept point is computed. At block 1408B, it is determined whether the CC2 is less than or equal to CC1 and CC3 is less than or equal to CC1. At block 1410B, it is declared that the intercept point lies on the arc joining the start point and end point if the CC2 is less than or equal to CC1 and CC3 is less than or equal to CC1. At block 1412B, it is declared that the intercept point does not lie on the arc joining the start point and end point if the CC2 is greater than the CC1 and the CC3 is greater than the CC1.

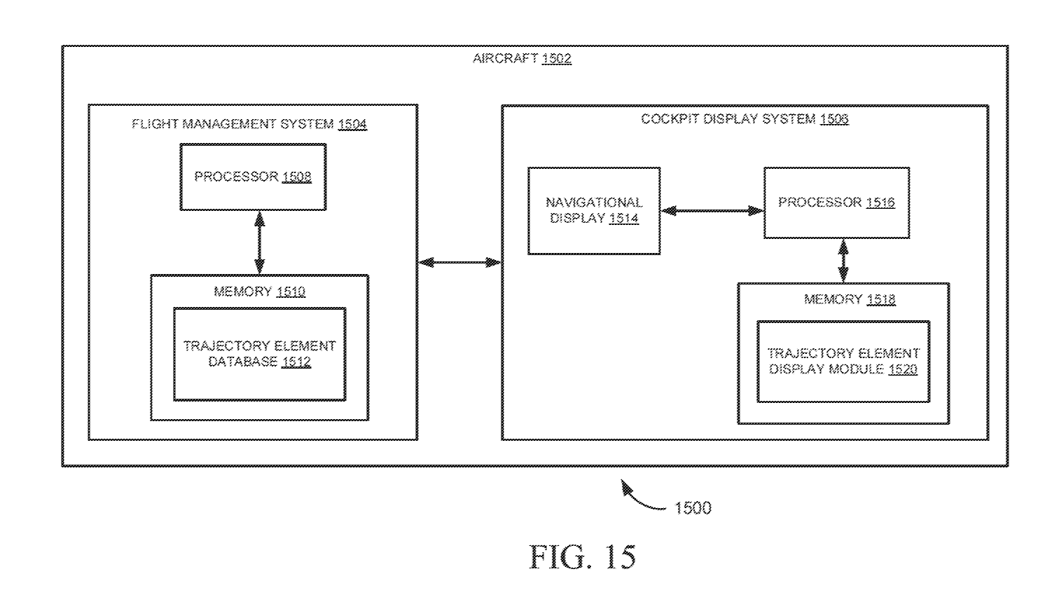

Referring now to FIG. 15, which is a block diagram 1500 illustrating an aircraft 1502 including a trajectory element display module 1520 for maximizing displaying of trajectory elements in an edit area of a navigational display 1514 of a cockpit display system 1506, according to one embodiment. As shown in FIG. 15, the aircraft 1502 includes a FMS 1504, the cockpit display system 1506 and other systems. Further, the FMS 1504 includes a processor 1508 and memory 1510. Furthermore, the memory 1510 includes a trajectory element database 1512. In addition, the cockpit display system 1506 includes the navigational display 1514, a processor 1516 and memory 1518. Moreover, the memory 1518 includes the trajectory element display module 1520.

Also, the cockpit display system 1506 is communicatively coupled to the FMS 1504. Further, the memory 1510 is the coupled to the processor 1508. Furthermore, the processor 1516 is coupled to the navigational display 1514. In addition, the memory 1518 is coupled to the processor 1516.

In operation, the trajectory element display module 1520 obtains navigational display parameters from the cockpit display system 1506. For example, the navigational display parameters include a map reference point (MRP), a range of the navigational display, an orientation of the navigational display, edit area boundary dimensions and the like. Further, the trajectory element display module 1520 obtains flight plan information from the trajectory element database 1512. For example, the flight plan information includes the flight path information, way point information, airport information, navigation aids information defined by points, lines and arcs and the like. Furthermore, the trajectory element display module 1520 dynamically determines which portion of the flight plan information lies within the edit area of the navigational display 1514 using the navigational display parameters. In one embodiment, the trajectory element display module 1520 partitions the edit area into quadrants. The trajectory element display module 1520 then determines which of the defined points, lines and arcs are within one or more of the quadrants of the edit area using point, line and arc logics, respectively.

In one exemplary embodiment, the trajectory element display module 1520 determines which of the defined points are within one or more of the quadrants of the edit area by computing a distance between each defined point and the MRP. Further, the trajectory element display module 1520 determines an orientation bearing angle with respect to a true north using a sodano equation. Furthermore, the trajectory element display module 1520 determines a line bearing angle of a line joining each defined point and the MRP with respect to the true north using the sodano equation. In addition, the trajectory element display module 1520 determines a bearing angle difference between the orientation bearing angle and the line bearing angle. Moreover, the trajectory element display module 1520 determines in which quadrant each defined point lies using the bearing angle difference. Also, the trajectory element display module 1520 determines whether the defined points lie within boundary limits of the determined quadrant. Further, the trajectory element display module 1520 declares the defined points to display in the edit area based on the outcome of the above determination.

In one exemplary embodiment, the trajectory element display module 1520 determines which of the defined lines are within one or more of the quadrants of the edit area, using the line logic, by determining whether a complete or a portion of each line is in the edit area using whether one of a start point position of the line, an end point position of the line, and an intercept point position on the line from the MRP is in the edit area using the point logic. Further, the trajectory element display module 1520 declares the defined lines to display in the edit area based on the outcome of the above determination.

In one exemplary embodiment, the trajectory element display module 1520 determines which of the defined arcs are within one or more of the quadrants of the edit area by determining whether a complete or a portion of each arc is in the edit area using whether one of a start point position of the arc, an end point position of the arc, and an intercept point position is in the edit area using the point logic. For example, the intercept point position is where the line joining a MRP and an arc center intercepts with the arc. Further, the trajectory element display module 1520 declares the arc to display in the edit area based on the outcome of the above determination.

In addition, the trajectory element display module 1520 dynamically populates a display buffer with only the determined portion of the flight plan information. Moreover, the trajectory element display module 1520 dynamically refreshes any needed data that is in the determined portion of the flight plan information in the display buffer. For example, the data includes trajectory elements, such as airports, geographical waypoints, non-directional navigation beacons, landmarks on or near a flight path, arrival locations, and the like. Also, the trajectory element display module 1520 dynamically displays the flight plan information on the edit area of the navigational display 1514 using the refreshed and populated flight plan information and the needed data.

In various embodiments, the system and method described in FIGS. 1 through 15 propose the trajectory element display module for maximizing displaying of the trajectory elements in the edit area of the navigational display of the cockpit display system. Further, the trajectory element display module displays the flight plan information on the edit area of the navigational display using the refreshed and populated flight plan information and the needed data, thus improving the usefulness of the navigational display in a decision process during the flight.

Although certain methods, systems, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method of maximizing displaying of trajectory elements in an edit area of a navigational display of a cockpit display system, comprising:
obtaining navigational display parameters from the cockpit display system;
obtaining flight plan information from a flight management system (FMS);
dynamically determining which portion of the flight plan information lies within the edit area of the navigational display using the navigational display parameters;
dynamically populating a display buffer with only the determined portion of the flight plan information;
dynamically refreshing any needed data that is in the determined portion of the flight plan information in the display buffer; and
dynamically displaying the flight plan information on the edit area of the navigational display using the refreshed and populated flight plan information and the needed data.

2. The method of claim 1, wherein the navigational display parameters are selected from the group consisting of a map reference point (MRP), a range of the navigational display, an orientation of the navigational display, and edit area boundary dimensions.

3. The method of claim 1, wherein the flight plan information includes the flight path information, way point information, airport information, and navigation aids information defined by points, lines and arcs.

4. The method of claim 3, wherein determining which portion of the flight plan information lies within the edit area of the navigational display comprises:
partitioning the edit area into quadrants; and
determining which of the defined points, lines and arcs are within one or more of the quadrants of the edit area using point, line and arc logics, respectively.

5. The method of claim 4, wherein determining which of the defined points are within the edit area of the navigational display using the point logic comprises:
computing a distance between each defined point and a MRP;
determining an orientation bearing angle with respect to a true north using a sodano equation;
determining a line bearing angle of a line joining each defined point and the MRP with respect to the true north using the sodano equation;
determining a bearing angle difference between the orientation bearing angle and the line bearing angle;
determining in which quadrant each defined point lies using the bearing angle difference;
determining whether the defined points lie within boundary limits of the determined quadrant; and
declaring the defined points to display in the edit area based on the outcome of the above determination.

6. The method of claim 4, wherein determining which of the defined lines are within the edit area of the navigational display using the line logic comprises:
determining whether a complete or a portion of each line is in the edit area using whether one of a start point position of the line, an end point position of the line, and an intercept point position on the line from a MRP is in the edit area using the point logic; and
declaring the defined lines to display in the edit area based on the outcome of the above determination.

7. The method of claim 4, wherein determining which of the defined arcs are within the edit area of the navigational display using the arc logic comprises:
determining whether a complete or a portion of each arc is in the edit area using whether one of a start point position of the arc, an end point position of the arc, and an intercept point position is in the edit area using the point logic, wherein the intercept point position is where the line joining a MRP and an arc center intercepts with the arc; and
declaring the defined arcs to display in the edit area based on the outcome of the above determination.

8. The method of claim 1, wherein the data includes the trajectory elements selected from the group consisting of airports, geographical waypoints, non-directional navigation beacons, landmarks on or near a flight path, and arrival locations.

9. An aircraft, comprising:
a flight management system (FMS), wherein the FMS comprises:
a processor; and
memory coupled to the processor, wherein the memory includes a trajectory element database to store flight plan information; and
a cockpit display system communicatively coupled to the FMS, wherein the cockpit display system comprises:
a navigational display;
a processor coupled to the navigational display; and
memory coupled to the processor, wherein the memory includes a trajectory element display module to:
obtain navigational display parameters from the cockpit display system;
obtain the flight plan information from the trajectory element database;
dynamically determine which portion of the flight plan information lies within the edit area of the navigational display using the navigational display parameters;
dynamically populate a display buffer with only the determined portion of the flight plan information;
dynamically refresh any needed data that is in the determined portion of the flight plan information in the display buffer; and
dynamically display the flight plan information on the edit area of the navigational display using the refreshed and populated flight plan information and the needed data.

10. The aircraft of claim 9, wherein the navigational display parameters are selected from the group consisting of a map reference point (MRP), a range of the navigational display, an orientation of the navigational display, and edit area boundary dimensions.

11. The aircraft of claim 9, wherein the flight plan information includes the flight path information, way point information, airport information, and navigation aids information defined by points, lines and arcs.

12. The aircraft of claim 11, wherein the trajectory element display module is configured to:
partition the edit area into quadrants; and
determine which of the defined points, lines and arcs are within one or more of the quadrants of the edit area using point, line and arc logics, respectively.

13. The aircraft of claim 12, wherein the trajectory element display module is configured to:
compute a distance between each defined point and a MRP;
determine an orientation bearing angle with respect to a true north using a sodano equation;
determine a line bearing angle of a line joining each defined point and the MRP with respect to the true north using the sodano equation;
determine a bearing angle difference between the orientation bearing angle and the line bearing angle;
determine in which quadrant each defined point lies using the bearing angle difference;
determine whether the defined points lie within boundary limits of the determined quadrant; and
declare the defined points to display in the edit area based on the outcome of the above determination.

14. The aircraft of claim 12, wherein the trajectory element display module is configured to:
determine whether a complete or a portion of each line is in the edit area using whether one of a start point position of the line, an end point position of the line, and an intercept point position on the line from a MRP is in the edit area using the point logic; and
declare the defined lines to display in the edit area based on the outcome of the above determination.

15. The aircraft of claim 12, wherein the trajectory element display module is configured to:
determine whether a complete or a portion of each arc is in the edit area using whether one of a start point position of the arc, an end point position of the arc, and an intercept point position is in the edit area using the point logic, wherein the intercept point position is where the line joining a MRP and an arc center intercepts with the arc; and
declare the defined arcs to display in the edit area based on the outcome of the above determination.

16. The aircraft of claim 9, wherein the data includes trajectory elements selected from the group consisting of airports, geographical waypoints, non-directional navigation beacons, landmarks on or near a flight path, and arrival locations.

17. A non-transitory computer-readable storage medium for maximizing displaying of trajectory elements in an edit area of a navigational display of a cockpit display system having instructions that, when executed by a computing device, cause the computing device to:
obtain navigational display parameters from the cockpit display system;
obtain flight plan information from a flight management system (FMS);
dynamically determine which portion of the flight plan information lies within the edit area of the navigational display using the navigational display parameters;
dynamically populate a display buffer with only the determined portion of the flight plan information;
dynamically refresh any needed data that is in the determined portion of the flight plan information in the display buffer; and
dynamically display the flight plan information on the edit area of the navigational display using the refreshed and populated flight plan information and the needed data.

18. The non-transitory computer-readable storage medium of claim 17, wherein the navigational display parameters are selected from the group consisting of a map reference point (MRP), a range of the navigational display, an orientation of the navigational display, and edit area boundary dimensions.

19. The non-transitory computer-readable storage medium of claim 17, wherein the flight plan information includes the flight path information, way point information, airport information, and navigation aids information defined by points, lines and arcs.

20. The non-transitory computer-readable storage medium of claim 19, wherein determining which portion of the flight plan information lies within the edit area of the navigational display comprises:
partitioning the edit area into quadrants; and
determining which of the defined points, lines and arcs are within one or more of the quadrants of the edit area using point, line and arc logics, respectively.

21. The non-transitory computer-readable storage medium of claim 20, wherein determining which of the defined points are within the edit area of the navigational display using the point logic comprises:
computing a distance between each defined point and a MRP;
determining an orientation bearing angle with respect to a true north using a sodano equation;
determining a line bearing angle of a line joining each defined point and the MRP with respect to the true north using the sodano equation;
determining a bearing angle difference between the orientation bearing angle and the line bearing angle;
determining in which quadrant each defined point lies using the bearing angle difference;
determining whether the defined points lie within boundary limits of the determined quadrant; and
declaring the defined points to display in the edit area based on the outcome of the above determination.

22. The non-transitory computer-readable storage medium of claim 20, wherein determining which of the defined lines are within the edit area of the navigational display using the line logic comprises:
determining whether a complete or a portion of each line is in the edit area using whether one of a start point position of the line, an end point position of the line, and an intercept point position on the line from a MRP is in the edit area using the point logic; and
declaring the defined lines to display in the edit area based on the outcome of the above determination.

23. The non-transitory computer-readable storage medium of claim 20, wherein determining which of the defined arcs are within the edit area of the navigational display using the arc logic comprises:
determining whether a complete or a portion of each arc is in the edit area using whether one of a start point position of the arc, an end point position of the arc, and an intercept point position is in the edit area using the point logic, wherein the intercept point position is where the line joining a MRP and an arc center intercepts with the arc; and
declaring the defined arcs to display in the edit area based on the outcome of the above determination.

24. The non-transitory computer-readable storage medium of claim 17, wherein the data includes trajectory elements selected from the group consisting of airports, geographical waypoints, non-directional navigation beacons, landmarks on or near a flight path, and arrival locations.
